(19) United States
(12) Patent Application Publication
(10) Pub. No.: US 2024/0298268 A1
(43) Pub. Date: Sep. 5, 2024

(54) COMMUNICATING WITH A CELLULAR NETWORK

(71) Applicant: Nordic Semiconductor ASA, Trondheim (NO)

(72) Inventors: Samuli HEIKKINEN, Oulu (FI); Aki RANTALA, Oulu (FI)

(73) Assignee: Nordic Semiconductor ASA, Trondheim (NO)

(21) Appl. No.: 18/591,474

(22) Filed: Feb. 29, 2024

(30) Foreign Application Priority Data
Mar. 2, 2023 (GB) 2303113.1

(51) Int. Cl. H04W 52/02; H04W 4/14; H04W 60/04

(52) U.S. Cl. CPC H04W 52/0274; H04W 4/14; H04W 52/0235; H04W 60/04

(57) ABSTRACT

A radio device communicates with a 4G or 5G cellular network that comprises one or more cells and supports a 4G LTM PSM or 5G MICO power saving mode for devices registered to the cellular network. When the radio device is registered to the cellular network and has the power saving mode activated, in response to determining that the radio device has data to send to the cellular network, the radio device deactivates the power saving mode and searches for a suitable cell of the cellular network for sending the data. If the radio device is unable to find to any suitable cell of the cellular network for sending the data to the cellular network, it reactivates the power saving mode.

### CROSS REFERENCE TO RELATED APPLICATION

This application claims priority from Great Britain Application No. 2303113.1, filed Mar. 2, 2023, which application is incorporated herein by reference in its entirety.

### BACKGROUND OF THE INVENTION

This invention relates to a radio device, system and method for communicating with a cellular network that supports a power saving mode.

Within the field of digital cellular telecommunications, it is known for cellular networks, such as 3GPP 4G and 5G networks, to support a power saving mode that, when activated for a particular radio device (e.g. user equipment) that is registered to a network, enables the device to reduce the power consumption of its radio by reducing the frequency with which it must communicate with the network, compared with when the power saving mode is not activated. This may allow the device to turn off parts of its radio circuitry for extended periods of time, thus saving power. For instance, the device may not be expected to receive paging messages from the network while it is in the power saving state. Use of a power saving state can be particularly beneficial for battery-powered devices such as Internet of Things (IoT) sensors, as it may enable them to remain registered to a cellular network for months or years while being powered by a single lithium cell.

In known systems, such as 4G Long Term Evolution (LTE), a device may request the use of power saving mode (PSM) from a network, e.g. when attaching to the network or when performing a tracking area updating procedure. If the network accepts the use of PSM, it signals this to the device. The radio device may then activate power saving mode when it has no signalling or user data to send to the network. If the radio device subsequent does need to send data to the network, it deactivates the power saving mode and attempts to connect the network to send the data. However, if the device is unable to connect to a suitable cell, current approaches lead to an increase in power consumption.

Embodiments of the present invention seek to provide a more efficient approach to using a power saving mode.

### SUMMARY OF THE INVENTION

From a first aspect, the invention provides a radio device for communicating with a cellular network, wherein the cellular network comprises one or more cells and supports a power saving mode for devices registered to the cellular network, wherein the radio device is configured:
when the radio device is registered to the cellular network and has the power saving mode activated, in response to determining that the radio device has data to send to the cellular network, to deactivate the power saving mode and to search for a suitable cell of the cellular network for sending the data to the cellular network; and
in response to determining that the radio device is unable to find to any suitable cell of the cellular network for sending the data to the cellular network, to reactivate the power saving mode.

From a second aspect, the invention provides a radio communication system comprising:
a cellular network; and
a radio device for communicating with the cellular network, wherein the cellular network comprises one or more cells and supports a power saving mode for devices registered to the cellular network; and
   wherein the radio device is configured:
when the radio device is registered to the cellular network and has the power saving mode activated, in response to determining that the radio device has data to send to the cellular network, to deactivate the power saving mode and to search for a suitable cell of the cellular network for sending the data to the cellular network; and
in response to determining that the radio device is unable to find to any suitable cell of the cellular network for sending the data to the cellular network, to reactivate the power saving mode.

From a third aspect, the invention provides a method performed by a radio device for communicating with a cellular network, wherein the cellular network comprises one or more cells and supports a power saving mode for devices registered to the cellular network, the method comprising:
when the radio device is registered to the cellular network and has the power saving mode activated, the radio device determining that the radio device has data to send to the cellular network, and, in response, the radio device deactivating the power saving mode and searching for a suitable cell of the cellular network for sending the data to the cellular network; and
the radio device determining that the radio device is unable to find any suitable cell of the cellular network for sending the data to the cellular network, and, in response, the radio device reactivating the power saving mode.

Thus it will be seen that, in accordance with embodiments of the invention, the radio device can continue to save power (e.g. by not activating a radio receiver to listen for paging messages), even after it fails to find a suitable cell for sending the data.

There may be various reasons why a device is unable to find a suitable cell to camp on. For example, the radio device could be on board a ship that is at sea, out of range of any cellular base stations. This situation could persist for many days or weeks. By reactivating power saving mode, such a device may be able to continue to save power until such time as it is next able to connect successfully to the cellular network, which could be days or weeks later. This approach may therefore be highly effective at reducing power consumption.

The cellular network may comprise a 4G or 5G network. The radio device may be configured for communication with a 4G and/or 5G network. It may be configured to communicate in accordance with 3GPP narrow-band Internet-of-Things (NB-IoT) or LTE machine-type communication (LTE-M).

The power saving mode may be a mode such that, when the power saving mode is active, radio communication between the radio device and the cellular network is reduced compared with a state when the power saving mode is deactivated. The power saving mode may thus allow the radio device to save power. In particular, in some embodiments, the power saving mode is a mode in which the cellular network does not send paging messages to the radio device, and/or in which the radio device does not listen for paging messages from the cellular network.

In embodiments in which the cellular network supports LTE communication, the power saving mode may be an LTE Power Saving Mode (PSM). In embodiments in which the cellular network supports LTE, the radio device may be configured to enter an evolved packet system (EPS) mobility management (EMM) state EMM-REGISTERED.NO-CELL-AVAILABLE when activating (including when reactivating) the power saving mode. The radio device may be configured to reactivate the power saving mode from an EMM state other than EMM-REGISTERED.NORMAL-SERVICE (e.g. from an EMM state of EMM-REGISTERED.NO-CELL-AVAILABLE or EMM-REGISTERED.LIMITED-SERVICE).

In embodiments in which the cellular network supports 5G communication, the power saving mode may be a 5G Mobile Initiated Connection Only (MICO) mode.

The radio device may comprise radio transceiver circuitry at least a part of which is in a sleep state (e.g. powered off) when the power saving mode is active, and is in an awake state (e.g. powered up) when the power saving mode is deactivated.

Deactivating the power saving mode may at least comprise the radio device entering a different internal state. It may comprise the radio device activating (e.g. powering up) at least a part of the radio transceiver circuitry of the radio device.

Searching for a cell of the cellular network may comprise the radio device monitoring for radio synchronization signals from the cellular network (e.g. transmitted by one or more base stations of the cellular network). It may comprise the radio device performing a cell search procedure, e.g. a 4G or 5G cell search.

The radio device may be configured to determine that no suitable cell can be found after searching and finding no suitable cell. It may search across a set of channels. It may search across all supported channels of the radio device. A suitable cell may be a cell that the radio device is able to connect to for normal service. The radio device may determine that no suitable cell can be found when no cell can be found or when only one or more unsuitable cells can be found (i.e. cells from which the cellular network forbids the radio device to receive normal service).

The radio device (e.g. application software executing on the radio device) may be configured to cancel sending the data in response to determining that the radio device is unable to find a suitable cell. The radio device may be configured to buffer the data for sending at a later time, or may be configured to discard the data.

The radio device may comprise radio modem for communicating with the cellular network. The radio modem may comprise radio transceiver circuitry. It may optionally comprise one or more processors for executing software (e.g. radio firmware) for controlling the radio transceiver circuitry. The radio device may further comprise a processing system for executing one or more applications (e.g. application-layer programs). The processing system may comprise one or more processors and a memory. The memory may be configured for storing software for execution by the processing system. The radio device may provide an application-layer interface for communication between the radio modem and one or more applications.

In some embodiments, the radio modem is configured to determine that the radio device is unable to find to any suitable cell of the cellular network for sending the data (e.g. after searching through all supported channels), and to signal that no suitable cell can be found through the application-layer interface—e.g. to a software application executing on the radio device.

The radio modem may be configured to receive an instruction through the application-layer interface (e.g. from the software application) to cancel sending the data and/or to reactivate the power saving mode. The application may be arranged to send such an instruction when, for example, it no longer has a need to send the data, or in response to receiving a signal from the radio modem that no suitable cell can be found for sending the data. Thus the reactivating of the power saving mode, in response to determining that the radio device is unable to find to any suitable cell of the cellular network for sending the data to the cellular network, may involve both the application layer and the radio modem.

The radio device may be configured to start a first timer in response to a command from the cellular network—e.g. in response to a radio-resource-control (RRC) connection release command. The first timer may be an LTE T3324 timer. It may set the first timer to time a duration provided to the radio device by the cellular network. It may be configured to activate the power saving mode in response to the first timer expiring.

The radio device may be configured to start a second timer in response to a command from the cellular network—e.g. in response to said radio-resource-control (RRC) connection release command. The second timer may be a periodic-tracking-area-update timer, such as an LTE T3412 timer. It may set the second timer to time a duration provided to the radio device by the cellular network. It may be configured to deactivate the power saving mode and to search for a suitable cell of the cellular network in response to the second timer expiring. It may be configured to do this regardless of whether the radio device has data to send to the cellular network. After deactivating the power saving mode due to the second timer expiring, the radio device may be configured not to reactivate the power saving mode until after the radio device has found a suitable cell. When the network is an LTE network, the radio device may be forbidden from reactivating PSM before successfully signalling the periodic tracking area updating (TAU). The radio device may be configured to keep the second timer running (i.e. not to reset it) when deactivating the power saving mode in response to determining that the radio device has data to send to the cellular network and then reactivating the power saving mode in response to determining that the radio device is unable to find to any suitable cell. In this way, the radio device may still comply with a timer policy set by the cellular network, despite deactivating and reactivating the power saving mode. The deactivating and reactivating may thus be transparent to the cellular network.

The data may be up-link data such as user data (e.g. from an application on the radio device), or may be mobile-originating (MO) data such as an MO short-message-service (SMS) message. The data may be generated by an application (e.g. a software application) on the radio device (e.g. generated from signals from an environmental sensor such as a temperature sensor), or it may be received by the radio device from outside the radio device (e.g. if the radio device is a component within a larger device). The radio device may determine that it has data to send by a message being received over an application-layer interface within the radio device, or over an external interface of the radio device.

The radio device may be any device. It may be a sensor device. It may be an Internet-of-Things (IoT) device. It may be a self-contained device, such as a domestic appliance or a vehicle, or it may a component of a larger device. It may be a radio module for incorporation within another device. In some embodiments, it is an integrated circuit such as a system-on-chip (SoC). It may require one or more external components, such as a power supply, crystal oscillator, antenna, etc. in order to exchange radio signals with the cellular network.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain embodiments of the invention will now be described, by way of example only, with reference to the accompanying drawings, in which:

FIG. 1 is a schematic diagram of an exemplary communications system in accordance with embodiments of the invention;

FIG. 2 is a flow diagram showing power saving mode activation and deactivation in accordance with a conventional approach; and

FIG. 3 is a flow diagram showing power saving mode activation, deactivation and reactivation in accordance with embodiments of the invention.

### DETAILED DESCRIPTION

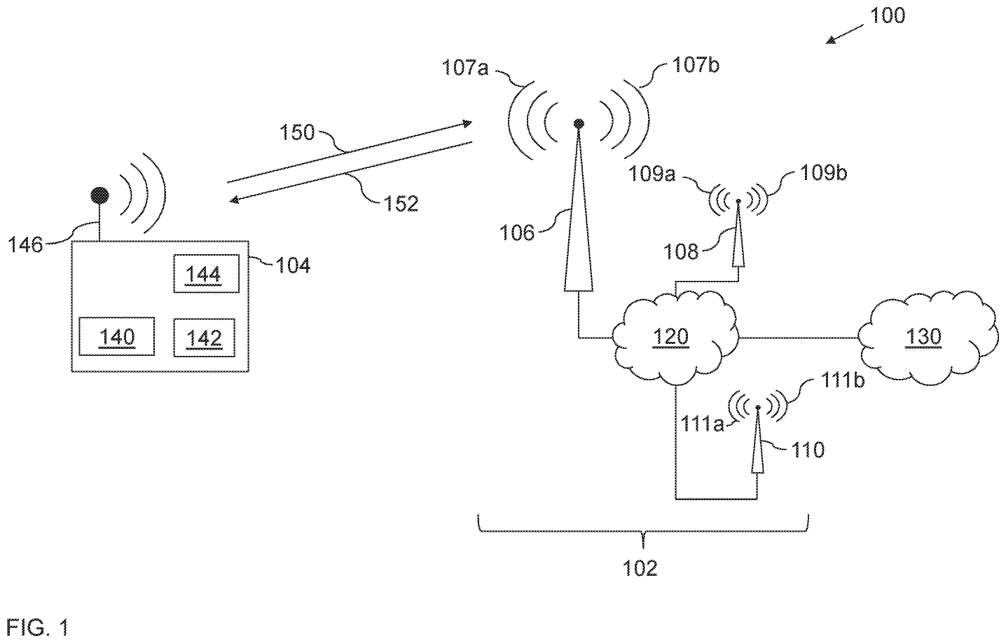

FIG. 1 shows an exemplary radio communications system 100. The system 100 includes a cellular telecommunications network 102 and an exemplary radio device 104 (also referred to herein as user equipment, or UE), which can communicate with the cellular network 102 by radio. The cellular network 102 includes a number of base stations 106, 108, 110 that each provide one or more respective cells 107a, 107b, 109a, 109b, 111a, 111b of the network 102. Each cell may be provided on a respective carrier and sector, and have a respective cell identifier. The base stations 106, 108, 110 are coupled to a backhaul network 120 of the cellular network 102. The backhaul network 120 may be coupled to a public data network 130 such as the Internet.

The cellular network 102 may support any generation of cellular technology, such as 4G or 5G network protocols. However, in some embodiments it comprises a 4G LTE network. At least some of the cells of the network 102 may comprise narrow-band Internet-of-Things (NB-IoT) or LTE-M. cells.

The UE 104 may be any form of device, such as a wireless sensor, a domestic appliance, a tracking tag, a vehicle, a mobile telephone, a laptop computer, etc. It could be a radio module contained within such a device. It could be a system on chip (SoC)—i.e. a radio-on-a-chip-which may be contained within another device or system. In some embodiments, it is an Internet-of-Things (IoT) device, such as a wireless sensor, that can communicate with the network 102 using NB-IoT or LTE-M.

The UE 104 includes a processing system 140, a memory 142 storing software for execution by the processing system 140, and radio transceiver circuitry 144 coupled to a radio antenna 146. The processing system 140 may execute software implementing a user-equipment cellular radio stack. It may also execute application-layer software, including one or more applications that use the radio circuitry 144 to send and/or receive user data over the cellular network 102. An application may, for instance, use the cellular radio system 100 to send data, such as sensor readings, at intervals to a remote server over the Internet 130.

When the UE 104 is camped on, with normal service, to a cell 107a provided by a base station 106 of the cellular network, the UE 104 can use its radio circuitry 144 can send uplink signals 150 to the base station 106 and can receive downlink signals 152 from base station 106.

In order to reduce the power consumption of its radio circuitry 144, when particular conditions are met, the UE 104 is able to activate a power saving mode (PSM), supported by the network 102. In this mode, the UE 104 is allowed to deactivate access stratum (AS) layers and stop paging reception in order to save power. It may put some of the radio circuitry 144 (e.g. any one or more of an amplifier, mixer, analog filter, digital filter, baseband processor, etc.) into a sleep state for longer than would otherwise be possible, in order to reduce the power consumption of the device 104.

In particular, in embodiments that support 3GPP 24,301, the UE 104 can first request the ability to use PSM during an attach or tracking area updating procedure (so long as the attach procedure does not relate to emergency bearer services or restricted local operator services). The network 102 accepts the use of PSM by providing a specific value for a timer T3324 when accepting the attach or tracking area updating procedure.

This PSM activation timer T3324 controls how long the UE 104 has to wait after radio-resource-control (RRC) connection release before entering PSM. T3324 might typically be set for a few seconds—e.g. 10 seconds. Upon expiry of the timer T3324, if appropriate conditions are met (e.g. relating to emergency bearer services and restricted local operator services), the UE 104 may choose to activate the PSM. This involves the UE 104 entering the state EMM-REGISTERED.NO-CELL-AVAILABLE. Conventionally, a UE would only ever activate PSM from the EMM-REGISTERED.NORMAL-SERVICE state. However, as explained below, that is not true of the present embodiments.

While the UE 104 is in PSM, the network 102 does not try to page UE 104.

The UE 104 may remain in the PSM state, with the AS layers deactivated, until the expiry of a periodic tracking-area update (TAU) timer T3412 or T3412ext, or until the UE 104 needs to signal for some other reason—e.g. an application running on the UE 104 has up-link (UL) data or a mobile-originating (MO) short-messaging-service (SMS) message to send over the network 102. The T3412/T3412ext timer controls how soon after RRC connection release the UE 104 must deactivate PSM and initiate periodic tracking-area updates, if there has not been any other reason to deactivate PSM before that (e.g. due to UL data). This timer T3412/T3412ext might be set to count for hours, days or even weeks before expiring, and can therefore allow for substantial power savings in appropriate contexts.

When UE 104 wakes up from PSM, it searches for a suitable cell 107a of the cellular network 102—i.e. for a cell that it can connect to for normal service. It searches through all supported channels and bands (sets of channels). However, it may sometimes be unable to find a suitable cell. This could be because the UE 104 is out of radio range of all network cells (e.g. if the UE 104 is a ship on the high seas, or in an aeroplane at high altitude). Alternatively, it could occur when the UE 104 is in range only of cells to which it is not permitted to attach with normal service, e.g. because these cells are in tracking areas or public land mobile networks (PLMN) that are forbidden to the UE 104.

When this occurs, the evolved packet system (EPS) mobility management (EMM) will not enter the state EMM-REGISTERED.NORMAL-SERVICE.

Conventionally, the UE 104 would then not reactivate the PSM state, even if the reason for it seeking to deactivate PSM ceases to apply (e.g. if the application layer cancels the sending of the up-link data or mobile-originating SMS message after a timeout period specific to the application use case).

If no cell is found during a first search round, the UE 104 continues periodically searching for a suitable cell. In this case the EMM state for the UE 104 may be EMM-REGISTERED.NO-CELL-AVAILABLE. When searching while registered, the EMM state is EMM-REGISTERED.PLMN-SEARCH, but if no cell is found the UE 104 will return to the EMM-REGISTERED.NO-CELL-AVAILABLE state, until a next search is undertaken after a period of time.

If the UE 104 finds a cell that is nominally “acceptable” (as specified by 3GPP) but on which the UE 104 is not allowed to signal, the UE 104 may camp on this cell and at the same time search for a suitable cell to which it can camp on for normal service. In this case the EMM state for the UE 104 may be EMM-REGISTERED.LIMITED-SERVICE.

In both cases, the transceiver circuitry 144 remains in a high-power state, even though there may be no application-level requirement to find a cell immediately (e.g. no longer an UL data to be sent).

This can therefore waste substantial power, especially since it is possible it could be hours, days or even weeks before the UE 104 is next in range of a suitable cell 107a. This may make it impracticable to deploy some types of device 104 (e.g. wireless NB-IoT or LTE-M sensors) into particular situations (e.g. on board a ship), or may require exceptionally large batteries to be provided.

Therefore, in accordance with the present disclosure, the UE 104 is configured to reactivate PSM if the reason for deactivating PSM ceases to apply—e.g. if the application layer cancels the sending of UL data of MO SMS.

In this approach, PSM reactivation is possible so long as the UE 104 has not signalled anything to network 102 since the original PSM activation, and the periodic TAU timer (T3412/T3412ext) has not yet expired. In particular, the UE 104 can reactivate PSM from any EMM state, and not only from the EMM-REGISTERED.NORMAL-SERVICE state. In some examples, it may reactive PSM from the EMM-REGISTERED.NO-CELL-AVAILABLE state or from the EMM-REGISTERED.LIMITED-SERVICE state. However, these are just two examples, and other scenarios may also be possible.

In these circumstances, the network 102 does not know that the UE 104 has performed PSM deactivation, and so the network 102 still considers that the UE 104 has PSM active. The network 102 is unaware that the PSM deactivation and reactivation have occurred on the UE 104. Consequently, no reconfiguration of the network 102 is required to support devices that implement this novel PSM reactivation mechanism, and so the present approach can be readily used with pre-existing networks 102.

Supporting reactivating PSM may be beneficial in many types of device, but may be especially useful for low-power IoT devices, since this can be expected to function for long periods (e.g. several years) on a small power supply such as a single lithium coin cell or small photovoltaic cell.

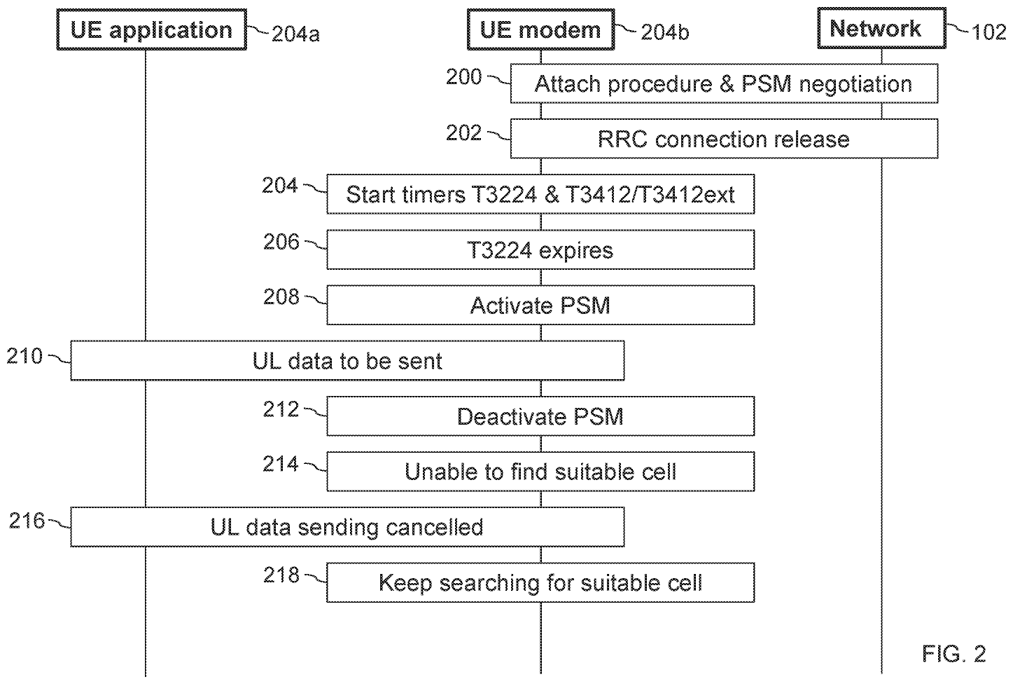

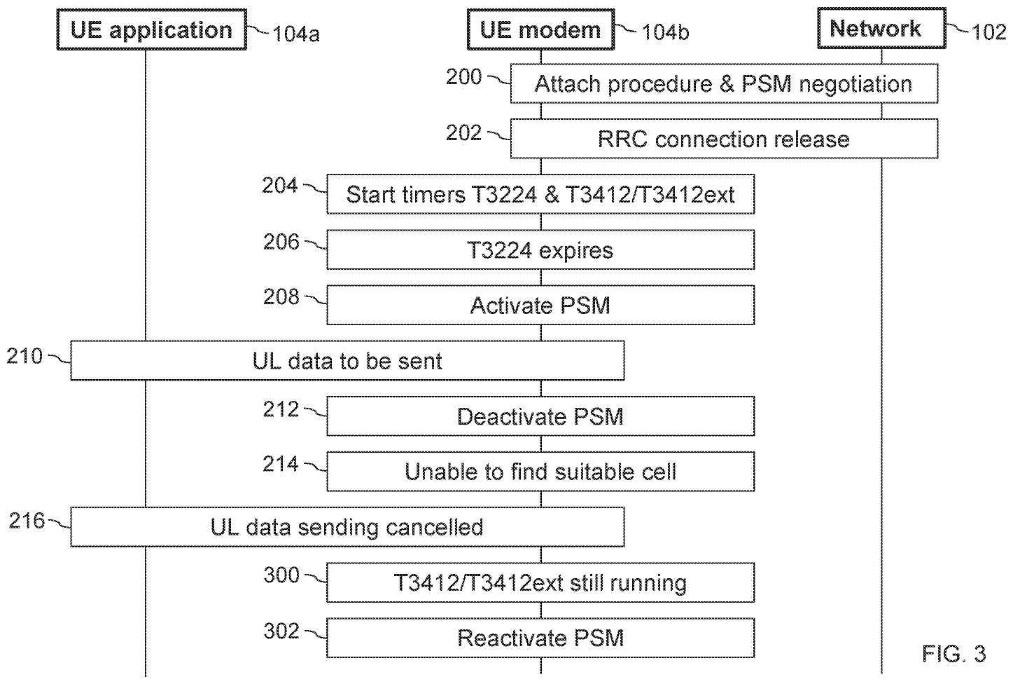

FIG. 2 shows an example scenario, in a 4G LTE context, in which a UE activates and deactivates power saving mode (PSM) using a conventional approach according to 3GPP 24,301. By contrast, FIG. 3 shows a similar scenario but where a UE 104 embodying the invention can activate, deactivate and then reactivate the PSM, resulting in further power savings.

FIG. 2 indicates different phases of the system over time, in a top downward direction. The three columns indicate respective actions or states of: the software application layer 204a of a UE; the UE's modem 204b (i.e. the hardware and optionally software implementing the cellular radio stack); and the cellular network 102. Where actions or states involve communication between two of these elements, this is represented by the corresponding rectangle spanning two columns.

In an initial phase 200, the UE modem 204b attaches to the cellular network 102 and performs a power saving mode (PSM) negotiation in which the UE indicates its desire to use PSM. The network 102 sends the UE a value to use for its PSM activation timer T3324 (e.g. ten seconds).

Sometime thereafter, the network 102 sends the UE an RRC connection release message 202, commanding the UE to release the RRC connection. Next 204, in response to the RRC connection release, the UE modem 204b starts a number of timers including the PSM activation timer T3324 and the periodic-tracking-area-update (TAU) timer T3412 or T3412ext.

After the T3224 timer expires 206, the UE modem 204b activates PSM 208. It deactivates the access stratum (AS) layers and stops listening for paging messages, and enters EMM state EMM-REGISTERED.NO-CELL-AVAILABLE. The UE remains registered with network at the non-access stratum (NAS) level, but is unable to immediately communicate with any base station (i.e. eNodeB) 106, 108, 110. This allows its radio transceiver circuitry and potentially its software processing system to save power by undertaking less activity.

When in the PSM, a UE application 204a may have a need to send up-link data to the cellular network 102 (e.g. a server over the Internet 130). Alternatively, it could desire to send a mobile-originating SMS message. It informs the modem 204b through an application-layer interface.

In response, the UE modem 204b deactivates PSM and starts searching for a suitable cell 212 (i.e. a cell that is acceptable and that permits the UE to attach and signal to the network 102).

In this example, it is unable to find a suitable cell 214. It may find no cell at all, or it may only be able to find a cell that is acceptable (i.e. available for the UE to camp on but only to obtain limited services such as emergency calling), and not suitable for obtaining normal service. In both cases, the UE is unable to send the up-link data. The modem 204b may signal this inability to the application 204a.

At some point in time, the application 204a may determine that the data sending should be cancelled (e.g. because the data has become old, according to a timer running within the application), and may instruct the modem 204b to cancel the sending of the UP data 216. Alternatively, in some embodiments, the modem 204b might itself cancel the sending after a timeout period, not in response to an instruction from an application. In some examples, the data may be buffered for sending at a later time, or it may be discarded.

In this conventional approach, the UE modem 204b continues periodically searching for a suitable cell indefinitely (at intervals determined by the UE modem 204b) until it finds such a cell or until the device runs out of power. It does not reactive PSM.

By contrast, in FIG. 3, a UE 104 embodying the invention may perform the same process between a UE application 104a, UE modem 104b and the cellular network 102, up until the cancelling 216 of the UL data sending by the application 104a (or by the modem 104b).

Thereafter, however, the UE modem 104b behave differently in that it checks 300 that the T3412 or T3412ext timer is still running (i.e. has not expired), and that it has not signalled to network 102 since the original PSM activation 208. If so, the UE modem 104b reactivates PSM. It sets the EMM state back to EMM-REGISTERED.NO-CELL-AVAILABLE and powers down at least some parts of the radio circuitry. It does not reset the timer T3412/T3412ext which continues to time from the RRC connection release 202.

This process of PSM deactivation and reactivation may occur several times before a suitable cell is found or before the T3412/T3412ext timer expires. Eventually, the T3412/T3412ext timer may expire, at which point the UE 104 will have to deactivate the PSM and not reactivate PSM until after the UE 104 has successfully attached to a suitable cell 106a. However, this approach may still result in substantial power savings during the period that the T3412/T3412ext timer is running, which could be for weeks or even months.

It will be seen from FIGS. 2 and 3 that the LTE cellular network 102 does not see any difference between the behaviour of the UE modem 204b acting conventionally and the UE modem 104b implementing a novel PSM reactivation procedure as disclosed herein.

Although exemplary embodiments have been described with reference to 4G LTE networks, it will be appreciated the same principles may be applied to other current and future cellular networks.

In particular, in some embodiments the UE may be configured to communicate with a 5G network, and the power saving mode referred to herein may be a Mobile Initiated Connection Only (MICO) mode. In this mode, a 5G network does not send paging messages to the UE, and a UE (e.g. an IoT device) does not need to listen for paging messages, and so can conserve battery power. The principles used in 5G MICO mode are similar to those in 4G PSM. The EPS mobility management (EMM) protocol in 4G is similar to the 5G mobility management (5GMM) protocol in 5G, and the 4G EMM states described herein have counterpart 5GMM states in 5G (with names starting “5GMM” instead of “EMM”).

It will be appreciated by those skilled in the art that the invention has been illustrated by describing one or more specific embodiments thereof, but is not limited to these embodiments; many variations and modifications are possible, within the scope of the accompanying claims.

1. A radio device for communicating with a 4G or 5G cellular network, wherein the cellular network comprises one or more cells and supports a 4G Long Term Evolution (LTE) Power Saving Mode (PSM) or a 5G Mobile Initiated Connection Only (MICO) power saving mode for devices registered to the cellular network,
wherein the radio device is configured:
when the radio device is registered to the 4G or 5G cellular network and has the 4G LTE PSM or 5G MICO power saving mode activated, in response to determining that the radio device has data to send to the cellular network, to deactivate the 4G LTE PSM or 5G MICO power saving mode and to search for a suitable cell of the cellular network for sending the data to the cellular network; and
in response to determining that the radio device is unable to find to any suitable cell of the 4G or 5G cellular network for sending the data to the cellular network, to reactivate the 4G LTE PSM or 5G MICO power saving mode.

2. The radio device of claim 1, wherein the radio device is configured not to listen for paging messages from the 4G or 5G cellular network when the radio device has activated the 4G LTE PSM or 5G MICO power saving mode.

3. The radio device of claim 1, wherein the cellular network supports 4G LTE communication, and wherein the power saving mode is a 4G LTE PSM power saving mode.

4. The radio device of claim 3, configured to enter an LTE evolved packet system (EPS) mobility management (EMM) state of EMM-REGISTERED.NO-CELL-AVAILABLE when activating and reactivating the 4G LTE PSM power saving mode.

5. The radio device of claim 4, configured to reactivate the 4G LTE PSM power saving mode from an EMM state other than EMM-REGISTERED.NORMAL-SERVICE.

6. The radio device of claim 1, wherein the cellular network supports 5G communication, and wherein the power saving mode is a 5G MICO mode.

7. The radio device of claim 1, configured to cancel sending the data in response to determining that the radio device is unable to find any suitable cell for sending the data, and to buffer the data for sending at a later time or to discard the data.

8. The radio device of claim 1, comprising a radio modem for communicating with the 4G or 5G cellular network and a processing system for executing a software application, wherein the radio device provides an application-layer interface for communication between the radio modem and the software application.

9. The radio device of claim 8, wherein the radio modem is configured to signal to the software application that the radio device is unable to find to any suitable cell of the 4G or 5G cellular network for sending the data.

10. The radio device of claim 8, wherein the radio modem is configured to receive from the software application an instruction to reactivate the 4G LTE PSM or 5G MICO power saving mode, and wherein the radio modem is configured to reactivate the 4G LTE PSM or 5G MICO power saving mode in response to the instruction.

11. The radio device of claim 8, wherein the radio modem is configured to receive from the software application an instruction to cancel sending the data, and wherein the radio modem is configured to reactivate the 4G LTE PSM or 5G MICO power saving mode in response to the instruction.

12. The radio device of claim 1, configured to start a timer in response to a command from the 4G or 5G cellular network, and further configured to deactivate the 4G LTE PSM or 5G MICO power saving mode and search for a suitable cell of the cellular network in response to the timer expiring, wherein the radio device is configured, after deactivating the 4G LTE PSM or 5G MICO power saving mode due to the timer expiring, not to reactivate the 4G LTE PSM or 5G MICO power saving mode until after the radio device has found a suitable cell.

13. The radio device of claim 12, configured to keep the timer running when deactivating the 4G LTE PSM or 5G MICO power saving mode in response to determining that the radio device has data to send to the 4G or 5G cellular network and when reactivating the 4G LTE PSM or 5G MICO power saving mode in response to determining that the radio device is unable to find to any suitable cell for sending the data to the cellular network.

14. The radio device of claim 1, wherein the data is up-link data or is a mobile-originating (MO) short-message-service (SMS) message.

15. The radio device of claim 1, wherein the radio device is a system-on-chip.

16. A radio communication system comprising:
a 4G or 5G cellular network, wherein the cellular network comprises one or more cells and supports a 4G Long Term Evolution (LTE) Power Saving Mode (PSM) or a 5G Mobile Initiated Connection Only (MICO) power saving mode for devices registered to the cellular network; and
a radio device for communicating with the 4G or 5G cellular network, wherein the radio device is configured:
when the radio device is registered to the 4G or 5G cellular network and has the 4G LTE PSM or 5G MICO power saving mode activated, in response to determining that the radio device has data to send to the cellular network, to deactivate the 4G LTE PSM or 5G MICO power saving mode and to search for a suitable cell of the cellular network for sending the data to the cellular network; and
in response to determining that the radio device is unable to find to any suitable cell of the 4G or 5G cellular network for sending the data to the cellular network, to reactivate the 4G LTE PSM or 5G MICO power saving mode.

17. A method performed by a radio device for communicating with a 4G or 5G cellular network, wherein the cellular network comprises one or more cells and supports a 4G Long Term Evolution (LTE) Power Saving Mode (PSM) or a 5G Mobile Initiated Connection Only (MICO) power saving mode for devices registered to the cellular network, the method comprising:
when the radio device is registered to the 4G or 5G cellular network and has the 4G LTE PSM or 5G MICO power saving mode activated, the radio device determining that the radio device has data to send to the cellular network, and, in response, the radio device deactivating the 4G LTE PSM or 5G MICO power saving mode and searching for a suitable cell of the cellular network for sending the data to the cellular network; and
the radio device determining that the radio device is unable to find any suitable cell of the 4G or 5G cellular network for sending the data to the cellular network, and, in response, the radio device reactivating the 4G LTE PSM or 5G MICO power saving mode.

18. The method of claim 17, wherein the cellular network comprises a 4G cellular network, and wherein the power saving mode is a 4G LTE Power Saving Mode (PSM), the method further comprising the radio device entering an LTE evolved packet system (EPS) mobility management (EMM) state of EMM-REGISTERED.NO-CELL-AVAILABLE when reactivating the 4G LTE PSM power saving mode.

19. The method of claim 18, comprising the radio device entering the 4G LTE PSM power saving mode from an EMM state other than EMM-REGISTERED.NORMAL-SERVICE.

20. The method of claim 17, wherein the cellular network comprises a 5G cellular network, and wherein the power saving mode is a 5G MICO mode.
